(19) United States
(12) Patent Application Publication
(10) Pub. No.: US 2003/0076765 A1
(43) Pub. Date: Apr. 24, 2003

(54) Holographic recording using contact prisms

(76) Inventors: Mark R. Ayres, Boulder, CO (US); Kevin R. Curtis, Longmont, CO (US)

Correspondence Address: Robert E. Scheid, Morrison & Foerster LLP, 425 Market Street, San Francisco, CA, 94105-2482, US

(21) Appl. No.: 10/106,292

(22) Filed: Mar. 25, 2002

Related U.S. Application Data
(60) Provisional application No. 60/346,803, filed on Oct. 18, 2001.

(51) Int. Cl. G11B 7/135

(52) U.S. Cl. 369/103; 369/112.28

(57) ABSTRACT

A method of holographic recording includes: generating a first object beam and a first reference beam; using a first prism at a first surface of a holographic medium to adjust an external entry angle of the first object beam into the holographic medium; and using the first prism to adjust an external entry angle of the first reference beam into the holographic medium. An interference between the first object beam and the first reference beam records a first hologram in the holographic medium.

### CROSS-REFERENCE TO RELATED APPLICATIONS

This application claims the benefit of provisional application No. 60/346,803, filed Oct. 18, 2001.

### TECHNICAL FIELD

The present invention relates to data storage generally and more particularly to holographic data storage.

### BACKGROUND ART

Holographic data storage densities depend on several factors including multiplexing selectivity (e.g., Bragg selectivity for angle multiplexing) and the size of the hologram.

Many geometries for holographic media have been proposed, but one of primary interest is a planar medium wherein the photoactive material lies between two substantially parallel surfaces. In this configuration, the object and reference beams must enter through the same or opposite surfaces, and Snell's law determines the angles of propagating rays:

θᵢₙₜₑᵣₙₐₗ=sin⁻¹(nₑₓₜₑᵣₙₐₗ/nᵢₙₜₑᵣₙₐₗ sin(θₑₓₜₑᵣₙₐₗ)). (1)

For the usual case where the refractive index of the medium is higher than the surrounding material (e.g., air where the index of refraction is nominally n=1), Snell's law dictates that the accessible angular range of internally propagating rays is less than the range of external angle. For example, if the index of the medium is 1.5, then the highest ray angle (with respect to the surface normal) that may be introduced into the medium is θᵢₙₜₑᵣₙₐₗ=sin⁻¹(1/1.5 sin(90°))=42°. Furthermore, as illustrated in FIG. 1, beams that are introduced at high angles undergo a large increase in their width according to cos(θₑₓₜₑᵣₙₐₗ)/cos(θᵢₙₜₑᵣₙₐₗ), leading to large hologram sizes when high bandwidth components are included.

This reduction of angle reduces the overall system capacity because multiplexing selectivity is impaired when the object and reference beams cross each other at small angles. FIG. 2 shows an example of an object beam and a reference beam intersecting in a planar holographic medium 61 where each beam is represented as a single ray (e.g., a central ray or a boundary ray). As indicated in FIG. 2, all angles are measured with respect to the normal. An object ray 63 enters the holographic medium 61 at an angle θₒ, refracts to an angle θₒ′ inside the medium 61, and refracts again to an angle θₒ when exiting the medium 61. Similarly, a reference ray 65 enters the holographic medium 61 at an angle θᵣ, refracts to an angle θᵣ′ inside the medium 61, and refracts again to an angle θᵣ when exiting the medium 61.

Multiplexing sensitivity to ray angles has been characterized for a variety of multiplexing methods. ([1] Barbastathis, G., Levene, M., and Psaltis, D., “Shift multiplexing with spherical reference waves,” Applied Optics, v. 35 n. 14, pp. 2403-2417, 1996; [2] Coufal, H. T., Psaltis, D., and Sincerbox, G. T. (eds.), Holographic Data Storage, Springer-Verlag, 2000.) For example, Bragg selectivity for angle multiplexing is typically given as.

$${Δθ}_{B} = \frac{λ}{L} \frac{cos {θ}_{o}}{sin ( {θ}_{r} + {θ}_{o} )}$$

where L is the thickness of the holographic medium, and λ is the wavelength of light ([2], p. 55). This function is minimized (for best selectivity) when the angle between the rays (i.e., θᵣ+θₒ) is 90°. However, this formula ignores the refractive effects described above, whereby the angle between the rays narrows due to Snell's law. Then, for example, for rays entering an n=1.5 medium from the same surface, a separation of 90° is not possible, and for realistic reference and object rays, the effective separation angle will be considerably lower.

Thus, there is a need for holographic recording that provides a larger range of angles for holographic storage.

### SUMMARY OF THE INVENTION

In one embodiment of the present invention, a method of holographic recording includes: generating a first object beam and a first reference beam; using a first prism at a first surface of a holographic medium to adjust an external entry angle of the first object beam into the holographic medium; and using the first prism to adjust an external entry angle of the first reference beam into the holographic medium. An interference between the first object beam and the first reference beam records a first hologram in the holographic medium.

According to one aspect, the method may be extended to include the recording of multiple holograms. Then, when recording a second hologram, the second reference beam may be adjusted according to a multiplexing method such as angular multiplexing, shift multiplexing, wavelength multiplexing, peristrophic multiplexing, or phase-code multiplexing.

According to another aspect, the first prism has an index of refraction that is approximately equal to an index of refraction of the holographic medium. Then undesirable refraction at the interfaces between the prism and the medium can be avoided.

According to another aspect, the method may include movement of the first prism for contact with the holographic medium. The method may also include acts that enhance the contact between the first prism and the medium and thereby avoid undesirable refraction. For example, an index-matching fluid or a soft index-matched material may be applied at the interface between the first prism and the medium. Additionally, an ionizing static reduction system may be used to reduce contamination of the first prism and the holographic medium.

According to another aspect, the placement of the first prism may include additional desirable qualities for holographic recording. Preferably, a characteristic ray of an object beam is normal to an object surface of the first prism. Preferably, a characteristic ray of a reference beam is normal to a reference surface of the first prism.

According to another aspect, the first surface of the holographic medium and the second surface of the holographic medium define two substantially parallel planes. The present invention thereby enables use of planar holographic medium for holographic recording.

According to another aspect, the first prism may be moved in order to enable movement of the holographic medium. Then holograms can be recorded when the first prism is in an active configuration, and the holographic medium can be moved when the first prism is in a non-active configuration. For example, when the first prism is in a non-active configuration, the holographic medium may be moved within a plane defined by the holographic medium (e.g., for a planar medium).

According to another aspect, the method may be extended to include using a second prism at a second surface of the holographic medium to adjust an external exit angle of the first object beam from the holographic medium. Preferably the second prism is substantially identical to the first prism so that desirable symmetries are maintained. Many aspects described above for the first prism are likewise applicable to the second prism (e.g. indices of refraction, movement of the prisms, etc.) Additionally, the prisms may be desirably arranged so that an object beam has an even symmetry with respect to a plane halfway between the object surface of the first prism and the object surface of the second prism.

In another embodiment of the present invention, a method of holographic reading includes: generating a first reference beam; using a first prism at a first surface of a holographic medium to adjust an external entry angle of the first reference beam into the holographic medium; and using a second prism at a second surface of the holographic medium to adjust an external exit angle of a first object beam from the holographic medium. A diffraction of the first reference beam from a first hologram in the holographic medium generates the first object beam (i.e., reconstructed object beam). This embodiment of the present invention may include aspects described above. For example, multiple holograms may be read (e.g., via a multiplexing method) and the prisms may be moved between reading operations.

In another embodiment of the present invention, an apparatus for recording holograms includes a holographic medium and a first prism. The first prism has a contact surface for contact with a first surface of the holographic medium, an object surface for entry of an object beam into the first prism, and a reference surface for entry of a reference beam into the first prism. The first prism is disposed so that the object beam enters the first prism at its object surface, exits the first prism at its contact surface, and enters the holographic medium at its first surface, and the reference beam enters the first prism at its reference surface, exits the first prism at its contact surface, and enters the holographic medium at its first surface. An interference between the object beam and the reference beam records a hologram in the holographic medium.

This embodiment of the present invention may include aspects described above. According to another aspect, the apparatus may include a reference beam source for generating the reference beam and a object beam source for generating the object beam.

According to another aspect, the apparatus may include one or more mechanisms for moving the first prism and for moving the holographic medium. Then holograms can be recorded when the prism (or mechanism) is in an active configuration, and the holographic medium can be moved when the prism (or mechanism) is in a non-active configuration.

According to another aspect, the apparatus may further include a second prism, where the second prism has a contact surface for contact with a second surface of the holographic medium and an object surface for exit of the object beam from the holographic medium. Then aspects described above regarding the inclusion of the second prism are likewise applicable (e.g., movement mechanisms).

In another embodiment of the present invention, an apparatus for reading holograms includes a holographic medium, a first prism, and a second prism. The first prism has a contact surface for contact with a first surface of the holographic medium, and a reference surface for entry of a reference beam into the first prism. The second prism has a contact surface for contact with a second surface of the holographic medium, and an object surface for exit of an object beam from the second prism. The first prism is disposed so that the reference beam enters the first prism at its reference surface, exits the first prism at its contact surface, and enters the holographic medium at its first surface. A diffraction of the reference beam from a hologram in the holographic medium generates an object beam. The second prism is disposed so that the object beam exits the holographic medium at its second surface, enters the second prism at its contact surface, and exits the second prism at its object surface. This embodiment of the present invention may further include aspects described above. (e.g., beam sources, movement mechanisms) The present invention enables holographic recording and reading with a relatively large range of angles for holographic storage. The invention requires relatively few components and is particularly applicable to holographic storage and retrieval with in a planar holographic medium.

### BRIEF DESCRIPTION OF THE DRAWINGS

FIG. 1 shows a widening of a beam due to refraction.

FIG. 2 shows intersecting reference and object rays in a planar medium.

FIG. 3 shows an embodiment of the present invention using prisms with a planar medium.

FIG. 4A shows intersecting object and reference rays in the planar medium of FIG. 3 without the prisms.

FIG. 4B shows intersecting object and reference rays in the embodiment shown in FIG. 3.

FIG. 5A shows an embodiment of the present invention in a non-active configuration.

FIG. 5B shows the embodiment of FIG. 5A in an active configuration.

### DETAILED DESCRIPTION OF EXEMPLARY EMBODIMENTS.

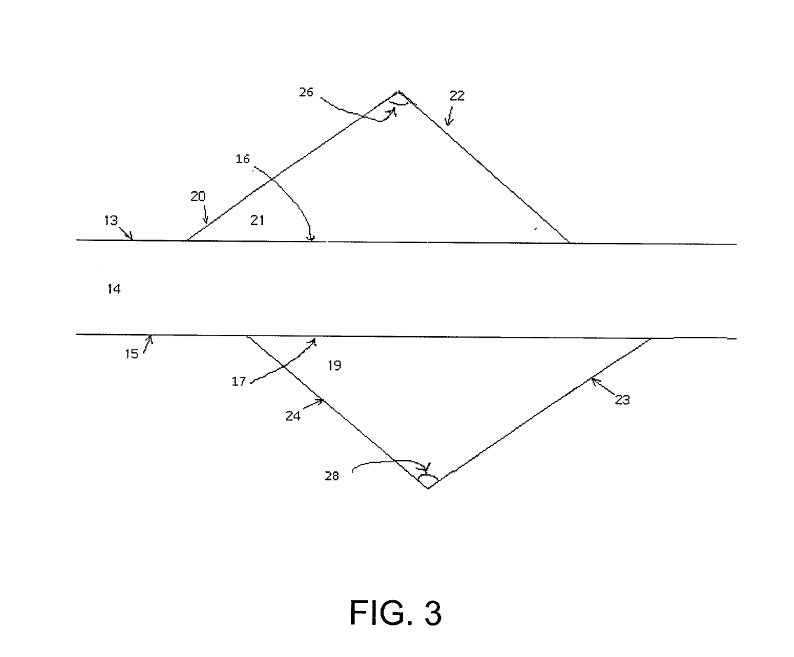

An embodiment of the present invention is shown in FIG. 3. Contact surfaces 16, 17 of an upper prism 21 and a lower prism 19 are in contact with a planar holographic medium 14 at upper and lower surfaces 13, 15 respectively. In addition to their contact surfaces 16, 17, the prisms 19, 21 provide separate surfaces (or faces) for object and reference beams to enter the medium 14, thereby creating greater control over the angles at which these beams intersect. The upper prism 21 has an object surface 20 and a reference surface 22, which are joined at a design angle 26, for entering object beams and reference beams, and likewise the lower prism 19 has an object surface 23 and a reference surface 24, which are joined at a design angle 28, for exiting object beams and reference beams.

The view in FIG. 3 is a side elevation view, but it also characterizes vertical cross-sections, where the depth dimension (i.e., depth into the page) depends on the operational setting. That is, for the embodiment shown in FIG. 3, vertical cross-sections parallel to the plane of the page are uniform for the prisms 19, 21 and the medium 14.

Note that the designations upper and lower have been used here for labeling purposes only and are not intended to be limiting. Other designations (e.g., first/second) are alternatively applicable to describing embodiments of the present invention. The designation first, whether in time or in space, does not imply a second item. Additionally, the designations for surfaces of the prisms as contact surfaces, object surfaces and reference surfaces are for labeling purposes only based on their use in the embodiment shown and are not intended to be physically limiting.

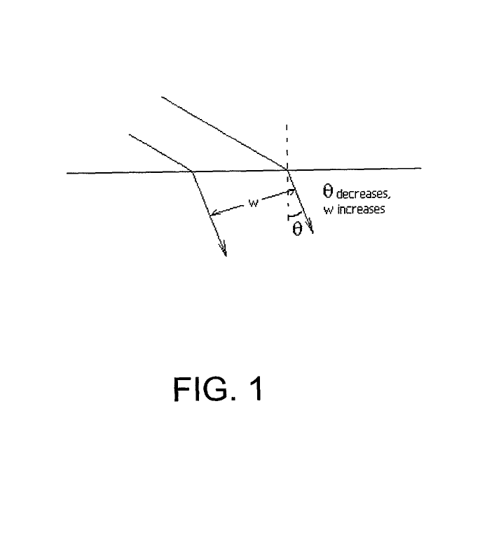

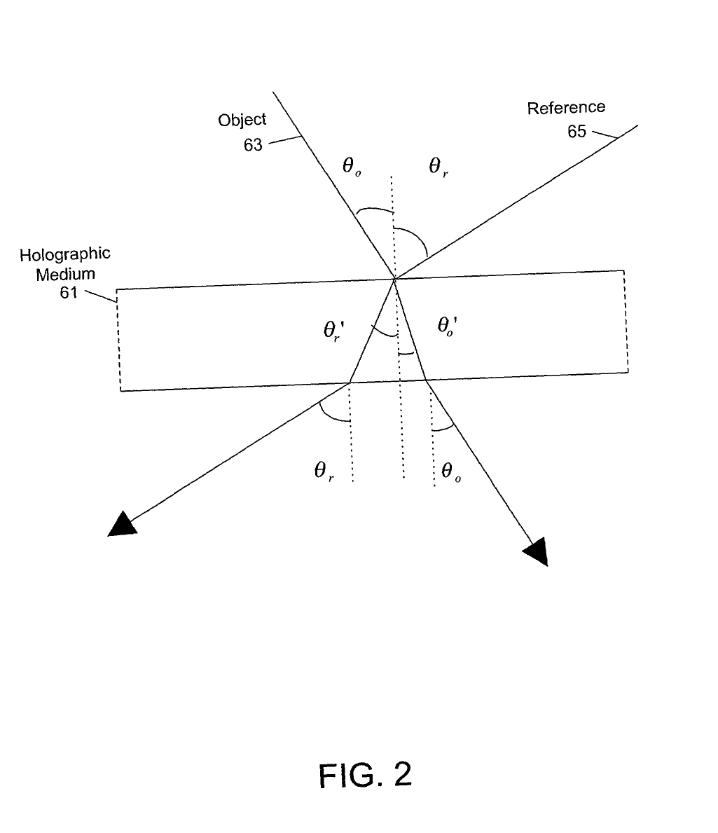

Preferably, the design angles 26, 28 are equal to maintain parallel structure of the rays on either side of the medium (cf. FIG. 2). And preferably these angles 26, 28 are approximately 90°, although values may be taken from a larger range (e.g., 40°-150°) and still achieve advantages in holographic storage. In the embodiment shown in FIG. 1, the design angles 26, 28 are approximately 108°.

In the embodiment shown in FIG. 3, the prismsl 9, 21 each have an index of refraction n=1.5, which is the same as the index of refraction of the medium 14. In many operational settings it is desirable for the indices to be substantially equal (e.g., within 1-5% or some application-specific tolerance) so that refraction at the interfaces is negligible (or substantially limited). More generally, the refractive index of the prisms 19, 21 may be chosen to produce the desired beam bending (or lack thereof) at the prism-media interfaces in accordance with Snell's law. In the case where the prisms 19, 21 are index-matched to the medium 14, no ray bending will occur at the interface between the prisms 19, 21 and the medium 14.

As discussed above, angular multiplexing may be employed, for example, where the Bragg selectivity is typically given as:

$${Δθ}_{B} = \frac{λ}{L} \frac{cos ( {θ}_{o} )}{sin ( {θ}_{r} + {θ}_{o} )} . \qquad ( 2 )$$

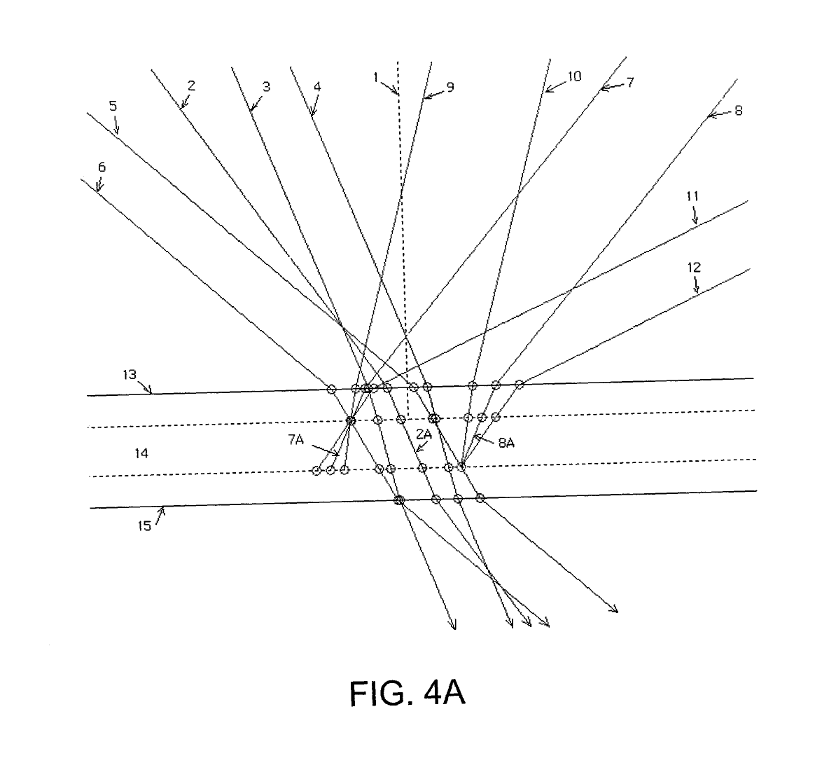

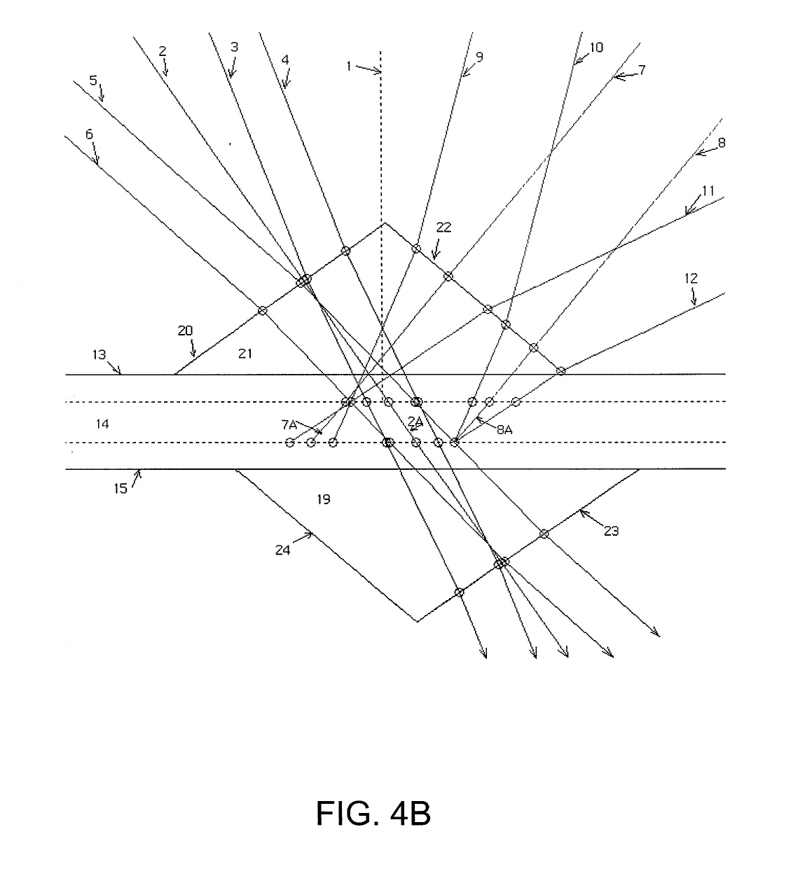

In terms of the internal angles, the Bragg selectivity can be characterized as:

$${Δθ}_{B}^{′} = \frac{λ}{nL} \frac{cos ( {θ}_{o}^{′} )}{sin ( {θ}_{r}^{′} + {θ}_{o}^{′} )} . \qquad ( 3 )$$

where n is the refractive index of the holographic medium 14. Then by employing the prisms 19, 21, greater control over these angles can be attained in accordance with Snell's Law (Eq. 1). To illustrate this operation, FIGS. 4A and 4B show characteristic properties of reference and object beams in the holographic medium 14 both without the prisms 19, 21 and with the prisms 19, 21. In these examples the behavior of the beams is shown by characteristic rays (e.g., central rays, boundary rays) and Snell's law is applied.

FIG. 4A illustrates holographic recording with the medium 14 using angular multiplexing without the prisms 19, 21. An object beam, which is characterized by a central ray 2 and additional surrounding rays 3, 4, 5, 6 that determine the edges of the object beam, enters the medium 14 at the upper surface 13. The central ray 2 of the object beam is incident upon the upper surface 13 of the medium 14 at an angle of incidence of θₒ=35° with respect to the medium surface normal 1. The medium 14 has index of refraction n=1.5, so an internal central object ray 2A corresponding to the central ray 2 propagates at θₒ′=22.48° with respect to the surface normal 1. The surrounding object rays 3, 4, 5, 6 are similarly refracted at the upper surface of the medium 13 according to Snell's law.

A first pair of reference rays 7, 8 represent the edges of a first reference beam at the center of the device's scanning range; they each make an angle of incidence of θᵣ=40° with respect to the medium surface normal 1. At the upper surface 13 of the medium 14, they are refracted to create internal reference rays 7A, 8A, each propagating at an angle of θᵣ′=25.37° with respect to the medium surface normal 1. The angular Bragg selectivity with respect to the central object ray can be used to estimate the overall selectivity in radians of the object beam according to Eq. 3 above. Taking λ=532 nm and L=1.5 mm, the resulting angular Bragg selectivity becomes Δθ_{B}′=294.4 μrad (0.01687°).

Similarly, a second pair of reference rays 9, 10 represent the edges of a second reference beam at the smallest angle in the device's scanning range, θ_{r,min}=15°. These reference rays 9, 10 are each refracted at an internal angle of θᵣ′_{,min}=9.936°, leading to an angular Bragg selectivity according to Eq. 3 of Δθ_{B}′_{,min}=407.5 μrad (0.02337°). A third pair of reference rays 11, 12 represent the edges of a third reference beam at the largest angle in the device's scanning range, θ_{r,max}=65° (θᵣ′_{r,max}=37.17°), leading to an angular Bragg selectivity Δθ_{B}′_{r,max}=253.1 μrad (0.01451°).

FIG. 4A also shows object rays 2, 3, 4, 5, 6 exiting from the lower surface 15 of the holographic medium 14 since these paths are relevant for reconstruction (or reading) of a holographic recording. That is, in the reconstruction of a hologram previously recorded in the medium 14, a reference beam enters at the upper surface 13 and a reconstructed object beam exits from the lower surface 15.

The angular Bragg selectivity Δθ_{B}′ represents the angular deviation of the internal reconstructing reference beam that will cause the diffraction efficiency of the recorded hologram to drop to zero. If two plane wave holograms are recorded using two different reference beams that are separated in angle by Δθ_{B}′, then the cross talk between the two holograms upon readout will be negligible. Thus Δθ_{B}′ represents the minimum angular reference beam separation for recording holograms without cross talk. The maximum number of holograms that may be recorded is found by dividing the total angular range by Δθ_{B}′. However, since Δθ_{B}′ itself changes slowly as a function of θᵣ′, numerical or analytical methods must be applied. In this case, iterative application of Eq. 3 within the angle scanning range between θᵣ′_{,min} and θᵣ′_{,max} (27.24°) gives an estimate of the maximum number of holograms as Nₕₒₗₒ=1550.

FIG. 4B illustrates holographic recording with the medium 14 using angular multiplexing with the prisms 19, 21. The same combinations of object rays 2, 3, 4, 5, 6 and reference rays 7, 8, 9, 10, 11, 12 are shown. As discussed above with reference to FIG. 3, the prisms 21 and 19 have an index of refraction n=1.5, which is the same as the index of refraction as the medium 14. The object surface 20 of the upper prism 21 is normal to the central ray 2 of the object beam, and the reference surface 22 is normal to reference rays 7, 8 that represent the edges of a first reference beam at the center of the relevant scanning range (i.e., central reference rays). Similarly, the object surface 23 of lower prism 19 is normal to the central ray 2 of the object beam. Such an arrangement can be realized, for example, if upper and lower prisms 19, 21 are identical and oriented at 1800 rotation with respect to one another.

Similarly as in FIG. 4A, FIG. 4B also shows object rays 2, 3, 4, 5, 6 exiting from the object surface 23 of the lower prism 19 since these paths are relevant for reconstruction (i.e., reading) of a holographic recording. Additionally the object rays 2, 3, 4, 5, 6 exiting from the object surface 23 of the lower prism 19 may be monitored during the recording process for diagnostic purposes (e.g., alignment monitoring, data verification, etc.).

The upper and lower prisms 19, 21 may also be positioned with respect to one another so that the object beam bounded by boundary object rays 3, 4, 5, 6 exhibits even symmetry with respect to the plane halfway between the parallel prism object surfaces 20, 23 as shown in FIG. 4B. In this case, the optical path of the object beam will satisfy the well-known symmetrical principle of optical design, and the imaging aberrations coma, distortion, and lateral color tend to zero. ([3] Smith, W. J., “Modem Optical Engineering,” 2^{nd} ed., McGraw-Hill 1990, p. 372.) This improves the data page image quality, and hence the detection SNR (signal-to-noise ratio) when compared to a non-symmetrical design such that as illustrated in FIG. 4A.

Since the central ray 2 of the object beam enters normally at the object surface 20 of the upper prism 21, the internal central object ray 2A propagates at θₒ′=θₒ=35° with respect to the medium surface normal 1. Similarly, the first pair of reference rays 7, 8, which represent the edges of a first reference beam, enter normally to the reference surface 22 of the upper prism 21 so that corresponding internal reference rays 7A, 8A propagate at θₒ′=θₒ=40° with respect to the medium surface normal 1. Consequently, according to Eq. 3, angular Bragg selectivity in the center of the device's scanning range becomes Δ74 _{B}′=200.5 μrad (0.01149°), which compares favorably with the non-contact prism case where Δθ_{B}′=294.4 μrad (0.01687°).

The second pair of reference rays 9, 10, which represent the edges of a second reference beam at the smallest angle in the device's scanning range, θ_{r,min}=15°, are refracted upon entry into the reference surface 22 of the upper prism 21 to an internal propagation angle of θᵣ′_{,min}=23.64° with respect to the medium surface normal 1. Similarly, the third pair of reference rays 11, 12, which represent the edges of a third reference beam at the largest angle in the device's scanning range, θ_{r,max}=65°, are refracted to an internal propagation angle of θᵣ′_{,max}=56.36°. Application of Eq. 3 indicates that the angular Bragg selectivity for these two reference beams is Δθ_{B}′_{,min}=226.8 μrad (0.01300°) and Δθ_{B}′_{,max}=193.7 μrad (0.01110°), respectively. Both of these results compare favorably with the non-contact-prism case (FIG. 4A) where Δθ_{B}′_{,min}=407.5 μrad (0.02337°) and Δθ_{B}′_{,max}=253.1 μrad (0.01451°).

Furthermore, the total internal angular range accessible by the scanner has been increased to θᵣ′_{,max}−θᵣ′_{,min}=32.78°, an improvement over the non-contact-prism case of 27.24°. Iterative application of Eq. 3 over this range indicates that the maximum number of holograms can be estimated as Nₕₒₗₒ=2810, an 81% increase over the non-contact-prism case.

Note that the examples presented above with reference to FIGS. 4A-4B include collimated reference beams (i.e., plane waves) and non-collimated object beams (i.e., superpositions of plane waves). Other combinations of beams for recording holograms are likewise possible.

Since the prisms 19, 21 introduce rays into the medium that might otherwise experience total internal reflection off the exiting surface of the prism, the separation between the prisms 19, 21 and the medium 14 should preferably be kept extremely small. If the separation is in the near-field regime (e.g., less than a couple hundred nanometers), most of the light can jump the gap through “frustrated total internal reflection.” However, even partial reflections off the prism-medium interfaces can be troublesome. For this reason, it is extremely important that contaminants between the prism and medium be avoided. Several methods can be used to address this:

1) Coating the medium and/or prism contact surfaces with an index-matching fluid. The fluid would tend to fill gaps in the interface, reducing the tendency for total-internal reflection.

2) Coating the prism contact surfaces and/or medium with a soft index-matched material, possibly a gel. The material would deform around contaminants and provide contact.

3) Employing an ionizing static-reduction system (e.g., a passive polonium-210 anti-static element) to reduce the incidence of contaminants that cling to the medium or prisms.

In addition to the application to angular multiplexing as described above, alternative multiplexing methods may be employed, where the greater angular control of the beams similarly leads to enhanced storage performance. For example, shift multiplexing may be used in accordance with the present invention. The Bragg selectivity for shift multiplexing is typically given as:

$${δ}_{Bragg} = \frac{λ {z}_{0}}{L sin {θ}_{o}} ,$$

where L is the thickness of the holographic medium, λ is the wavelength of light, z₀ is the distance from the reference source (a point source) to the holographic medium, and θₒ is the external angle of incidence for the object beam with respect to the holographic medium. ([1], p. 2404) From Snell's law the Bragg selectivity can be written in terms of the internal angle of propagation θₒ′ as:

$${δ}_{Bragg} = \frac{λ {z}_{0}}{L n sin {θ}_{o}^{′}} .$$

From this expression it is clear that δ_{Bragg} decreases (for best selectivity) as θₒ′ approaches 90°. Without contact prisms, the highest possible θₒ′ would be bounded by refraction at the medium surface (e.g., 42° for media with n=1.5). With contact prisms, θₒ′ can in principle approach 90° leading to improved shift selectivity.

In addition, wavelength multiplexing may be used in accordance with the present invention. The Bragg selectivity for wavelength multiplexing is generally given by ([2], p. 45):

$${Δλ}_{B} = \frac{{λ}^{2} cos {θ}_{o}}{2 L {sin}^{2} \frac{1}{2} ( {θ}_{r} + {θ}_{o} )} ,$$

where L is the thickness of the holographic medium, λ is the wavelength of light, and the angles θₒ and θᵣ are respectively the external angles of incidence for the object beam and the reference beams with respect to the holographic medium. A corresponding version with internal angles may also be derived analogously to the formula presented above for angular multiplexing (Eq. 3). Noting that internal angles increase monotonically with external angles, one observes that cos θₒ in the numerator decreases as θₒ increases, and that sin² ½(θᵣ+θₒ) increases as θᵣ+θₒ (the angle between the reference and signal beams) increases. Both of these influences will lead to better selectivity, and contact prism recording enables both.

In addition, peristrophic multiplexing may be used in accordance with the present invention. The Bragg selectivity for peristrophic multiplexing is typically given by ([2], p. 54)

$${Δψ}_{B} = {\{ \frac{2 λ}{L} \frac{cos {θ}_{o}}{sin {θ}_{r} ( sin {θ}_{r} + sin {θ}_{o} )} \}}^{1 / 2} ,$$

where L is the thickness of the holographic medium, λ is the wavelength of light, and the angles θₒ and θᵣ are respectively the external angles of incidence for the object beam and the reference beams with respect to the holographic medium. By the same argument as above, selectivity is improved when θₒ increases (causing cos θₒ to decrease and sin θₒ to increase), and θᵣ increases (causing sin θᵣ to increase).

In addition, phase-code multiplexing may be used in accordance with the present invention. Phase-code multiplexing is similar to angle multiplexing except that multiple plane waves (angles) are used at the same time ([2] pp. 45-47). Typically, the plane wave components have a binary phase value (0° or 180°) so that the collection of plane waves form a member of a Walsh-Hadamard code (all members of the code are mutually orthogonal, thus as reference beams they do not generate cross-talk). The individual plane waves are typically separated in angle by the angle multiplexing Bragg condition presented above. Thus, contact prisms would allow for more plane wave components and hence more Walsh-Hadamard coded reference beams.

Other embodiments of the present invention may result from the design of the prisms. The non-contacting surfaces of the prisms need not be flat; they may be curved to provide optical power. For example, if the entrance and exit surfaces of the object beam are given a convex curvature, the effective numerical aperture of the system will be increased, leading to a smaller Fourier spot size within the medium.

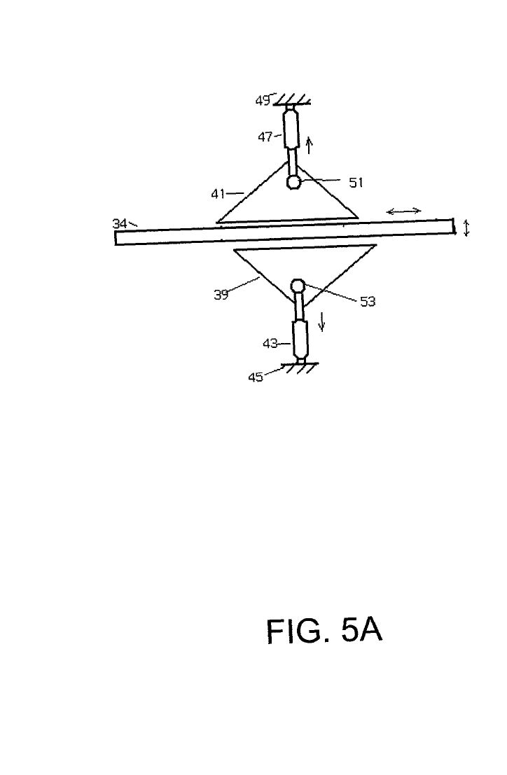

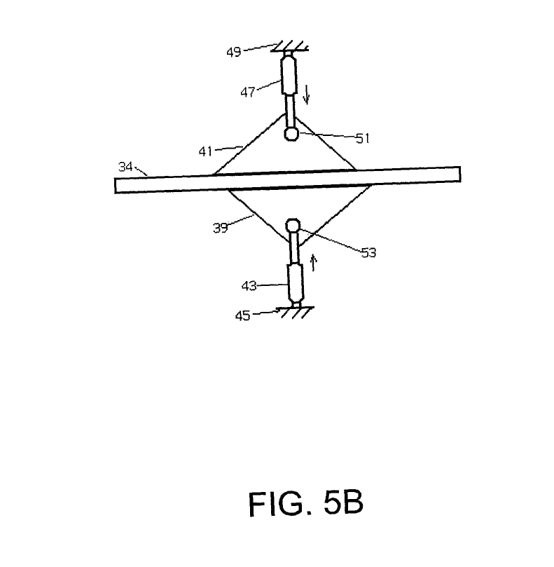

Other embodiments of the present invention may include additional features for spatial multiplexing, wherein stacks of holograms multiplexed by the methods described above are successively positioned in non-overlapping locations of the holographic medium. ([2], p. 27) Then mechanical systems for separation and contact may be employed to separate the prisms from the media surface and then re-contact them at a new recording location. FIGS. 5A and 5B show an embodiment of the present invention that includes mechanisms for contact of a lower prism 39 and an upper prism 41 with a holographic medium 34. A lower mechanical arm 43 (e.g., a lever/joint system) connects the lower prism 39 to a lower support position 45 where the connection point 53 is preferably pinned although other connections are possible. Likewise, a upper mechanical arm 47 connects the upper prism 41 to a upper support position 49 at a similar connection point 51.

As shown in FIGS. 5A and 5B, the arms 43, 47 enable movement of the prisms 39, 41 away from the medium 34 and toward the medium 34. FIG. 5A shows the mechanism in a non-active configuration with the arms 43, 47 positioned away from the medium 34 so that the prisms 39, 41 are separated from the medium 34, which can be moved in one or two spatial directions in a plane defined by the holographic medium 34 (e.g., by another mechanical arm and support point or by an alternative mechanical system). FIG. 5A shows visible separations between the prisms 43, 47 and the medium 34 so that the medium 34 can be moved easily. However, when the interfaces between the prisms 43, 47 and the medium 34 has been lubricated to allow closer contact (e.g., with an index-matching fluid or a soft index-matching material as described above), then the separations can be much less since the medium 34 can then slide between the prisms 43, 47. The non-active configuration shown in FIG. 5A may also be considered as a seek configuration since it is transitional between configurations where recording and reading can be done. FIG. 5B shows the mechanism in an active configuration with the arms 43, 47 positioned toward the medium 34 so that the prisms 39, 41 are in contact (or near-contact) with the medium 34, a configuration suitable for recording (or reading) holograms as discussed above.

In addition to improving the selectivity and decreasing the beam widths, specific embodiments of the present invention may desirably eliminate optical aberrations associated with imaging through an oblique plate. Optical aberrations can be eliminated because the resulting 4-f Spatial-Light-Modulator-to-camera imaging system can be made completely symmetrical about the line defining the waist of the object beam. Such a system is well known to cancel out all ‘transverse’ aberrations (e.g., coma, distortion, and lateral color). If the prisms are not present, the oblique angle of the medium makes this situation impossible unless the object beam is normal to the medium surface.

Additional mechanical advantages may result from the contact of the prisms with holographic medium (e.g., FIG. 5B) including improved ability to mechanically reference and control tilt of the medium and improved stability and shock immunity.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A method of holographic recording, comprising:
generating a first object beam and a first reference beam;
using a first prism at a first surface of a holographic medium to adjust an external entry angle of the first object beam into the holographic medium; and
using the first prism to adjust an external entry angle of the first reference beam into the holographic medium, wherein an interference between the first object beam and the first reference beam records a first hologram in the holographic medium.

2. A method according to claim 1, further comprising:
generating a second object beam and a second reference beam;
using the first prism to adjust an external entry angle of the second object beam into the holographic medium; and
using the first prism to adjust an external entry angle of the second reference beam into the holographic medium, wherein an interference between the second object beam and the second reference beam records a second hologram in the holographic medium.

3. A method according to claim 2, wherein generating the second object beam and the second reference beam includes adjusting the second reference beam with respect to the first reference beam according to a multiplexing scheme.

4. A method according to claim 3, wherein the multiplexing method is an angular multiplexing method.

5. A method according to claim 3, wherein the multiplexing method is a shift multiplexing method.

6. A method according to claim 3, wherein the multiplexing method is a wavelength multiplexing method.

7. A method according to claim 3, wherein the multiplexing method is a peristrophic multiplexing method.

8. A method according to claim 3, wherein the multiplexing method is a phase-code multiplexing method.

9. A method according to claim 1, wherein the first prism has an index of refraction that is approximately equal to an index of refraction of the holographic medium.

10. A method according to claim 1, further comprising:
placing a contact surface of the first prism in contact with the first surface of the holographic medium.

11. A method according to claim 10, further comprising:
applying an index-matching fluid to at least one of the contact surface of the first prism and the first surface of the holographic medium before placing the contact surface of the first prism in contact with the first surface of the holographic medium.

12. A method according to claim 10, further comprising:
applying a soft index-matched material to at least one of the contact surface of the first prism and the first surface of the holographic medium before placing the contact surface of the first prism in contact with the first surface of the holographic medium.

13. A method according to claim 10, further comprising:
using an ionizing static reduction system to reduce contamination of the first prism and the holographic medium before placing the contact surface of the first prism in contact with the first surface of the holographic medium.

14. A method according to claim 10, wherein a central ray of the first object beam is normal to an object surface of the first prism.

15. A method according to claim 10, wherein a central ray of the first reference beam is normal to a reference surface of the first prism.

16. A method according to claim 1, wherein the holographic medium is a planar medium.

17. A method according to claim 1, further comprising:
moving the first prism to a first active configuration before recording the first hologram;
moving the first prism to a non-active configuration after recording the first hologram;
moving the holographic medium relative to the first prism after the prism is in the non-active configuration.
moving the first prism to a second active configuration after moving the holographic medium.
generating a second object beam and a second reference beam when the first prism is in the second active configuration;
using the first prism to adjust an external entry angle of the second object beam into the holographic medium; and
using the first prism to adjust an external entry angle of the second reference beam into the holographic medium, wherein an interference between the second object beam and the second reference beam records a second hologram in the holographic medium.

18. A method according to claim 17, wherein the holographic medium is moved relative to the prisms in a direction within a plane defined by the holographic medium.

19. A method according to claim 1, further comprising: using a second prism at a second surface of the holographic medium to adjust an external exit angle of the first object beam from the holographic medium.

20. A method according to claim 19, further comprising:
generating a second object beam and a second reference beam;
using the first prism to adjust an external entry angle of the second object beam into the holographic medium;
using the first prism to adjust an external entry angle of the second reference beam into the holographic medium, wherein an interference between the second object beam and the second reference beam records a second hologram in the holographic medium; and
using the second prism to adjust an external exit angle of the second object beam from the holographic medium.

21. A method according to claim 20, wherein generating the second object beam and the second reference beam includes adjusting the second reference beam with respect to the first reference beam according to a multiplexing scheme.

22. A method according to claim 19, wherein the first prism and the second prism each have an index of refraction that is approximately equal to an index of refraction of the holographic medium.

23. A method according to claim 19, further comprising:
placing a contact surface of the first prism in contact with the first surface of the holographic medium; and
placing a contact surface of the second prism in contact with the second surface of the holographic medium.

24. A method according to claim 23, further comprising:
applying an index-matching fluid to at least one of the contact surface of the first prism and the first surface of the holographic medium before placing the contact surface of the first prism in contact with the first surface of the holographic medium; and
applying an index-matching fluid to at least one of the contact surface of the second prism and the second surface of the holographic medium before placing the contact surface of the second prism in contact with the second surface of the holographic medium.

25. A method according to claim 23, further comprising:
applying a soft index-matched material to at least one of the contact surface of the first prism and the first surface of the holographic medium before placing the contact surface of the first prism in contact with the first surface of the holographic medium; and
applying the soft index-matched material to at least one of the contact surface of the second prism and the second surface of the holographic medium before placing the contact surface of the second prism in contact with the second surface of the holographic medium.

26. A method according to claim 23, further comprising:
using an ionizing static reduction system to reduce contamination of the prisms and the holographic medium before placing the contact surface of the first prism in contact with the first surface of the holographic medium and before placing the contact surface of the second prism in contact with the second surface of the holographic medium

27. A method according to claim 23, wherein a central ray of the first object beam is normal to an object surface of the first prism and an object surface of the second prism.

28. A method according to claim 23, wherein the first object beam has an even symmetry with respect to a plane halfway between an object surface of the first prism and an object surface of the second prism.

29. A method according to claim 19, wherein the holographic medium is a planar medium.

30. A method according to claim 19, further comprising:
moving the prisms to a first active configuration before recording the first hologram;
moving the prisms to a non-active configuration after recording the first hologram;
moving the holographic medium relative to the prisms after the prisms are in the non-active configuration.
moving the prisms to a second active configuration after moving the holographic medium.
generating a second object beam and a second reference beam when the prisms are in the second active configuration;
using the first prism to adjust an external entry angle of the second object beam into the holographic medium;
using the first prism to adjust an external entry angle of the second reference beam into the holographic medium, wherein an interference between the second object beam and the second reference beam records a second hologram in the holographic medium; and
using the second prism to adjust an external exit angle of the second object beam from the holographic medium.

31. A method according to claim 30, wherein the holographic medium is moved relative to the prisms in a direction within a plane defined by the holographic medium.

32. A method of holographic reading, comprising:
generating a first reference beam;
using a first prism at a first surface of a holographic medium to adjust an external entry angle of the first reference beam into the holographic medium, wherein a diffraction of the first reference beam from a first hologram in the holographic medium generates a first object beam; and
using a second prism at a second surface of the holographic medium to adjust an external exit angle of the first object beam from the holographic medium.

33. A method according to claim 32, further comprising:
generating a second reference beam;
using the first prism to adjust an external entry angle of the second reference beam into the holographic medium, wherein a diffraction of the second reference beam from a second hologram in the holographic medium generates a second object beam; and
using the second prism to adjust an external exit angle of the second object beam from the holographic medium.

34. A method according to claim 33, wherein generating the second reference beam includes adjusting the second reference beam with respect to the first reference beam according to a multiplexing scheme.

35. A method according to claim 34, wherein the multiplexing method is an angular multiplexing method.

36. A method according to claim 34, wherein the multiplexing method is a shift multiplexing method.

37. A method according to claim 34, wherein the multiplexing method is a wavelength multiplexing method.

38. A method according to claim 34, wherein the multiplexing method is a peristrophic multiplexing method.

39. A method according to claim 34, wherein the multiplexing method is a phase-code multiplexing method.

40. A method according to claim 32, wherein the first prism and the second prism each have an index of refraction that is approximately equal to an index of refraction of the holographic medium.

41. A method according to claim 32, further comprising:
placing a contact surface of the first prism in contact with the first surface of the holographic medium; and
placing a contact surface of the second prism in contact with the second surface of the holographic medium.

42. A method according to claim 41, further comprising:
applying an index-matching fluid to at least one of the contact surface of the first prism and the first surface of the holographic medium before placing the contact surface of the first prism in contact with the first surface of the holographic medium; and
applying an index-matching fluid to at least one of the contact surface of the second prism and the second surface of the holographic medium before placing the contact surface of the second prism in contact with the second surface of the holographic medium.

43. A method according to claim 41, further comprising:
applying a soft index-matched material to at least one of the contact surface of the first prism and the first surface of the holographic medium before placing the contact surface of the first prism in contact with the first surface of the holographic medium; and
applying the soft index-matched material to at least one of the contact surface of the second prism and the second surface of the holographic medium before placing the contact surface of the second prism in contact with the second surface of the holographic medium.

44. A method according to claim 41, further comprising:
using an ionizing static reduction system to reduce contamination of the prisms and the holographic medium before placing the contact surface of the first prism in contact with the first surface of the holographic medium and before placing the contact surface of the second prism in contact with the second surface of the holographic medium

45. A method according to claim 41, wherein a central ray of the first object beam is normal to an object surface of the first prism and an object surface of the second prism.

46. A method according to claim 41, wherein a central ray of the first reference beam is normal to a reference surface of the first prism.

47. A method according to claim 41, wherein the first object beam has an even symmetry with respect to a plane halfway between an object surface of the first prism and an object surface of the second prism.

48. A method according to claim 32, wherein the holographic medium is a planar medium.

49. A method according to claim 32, further comprising:
moving the prisms to a first active configuration before reading the first hologram;
moving the prisms to a non-active configuration after reading the first hologram;
moving the holographic medium relative to the prisms after the prisms are in the non-active configuration.
moving the prisms to a second active configuration after moving the holographic medium;
generating a second reference beam when the prisms are in the second active configuration;
using the first prism to adjust an external entry angle of the second reference beam into the holographic medium, wherein a diffraction of the second reference beam from a second hologram in the holographic medium generates a second object beam; and
using the second prism to adjust an external exit angle of the second object beam from the holographic medium.

50. A method according to claim 49, wherein the holographic medium is moved relative to the prisms in a direction within a plane defined by the holographic medium.

51. An apparatus for recording holograms, comprising:
a holographic medium; and
a first prism, the first prism having a contact surface for contact with a first surface of the holographic medium, an object surface for entry of an object beam into the first prism, and a reference surface for entry of a reference beam into the first prism; wherein
the first prism is disposed so that the object beam enters the first prism at its object surface, exits the first prism at its contact surface, and enters the holographic medium at its first surface, and the reference beam enters the first prism at its reference surface, exits the first prism at its contact surface, and enters the holographic medium at its first surface, and
an interference between the object beam and the reference beam records a hologram in the holographic medium.

52. An apparatus according to claim 51, further comprising:
a reference beam source for generating the reference beam; and
an object beam source for generating the object beam.

53. An apparatus according to claim 51, wherein the first prism has an index of refraction that is approximately equal to an index of refraction of the holographic medium.

54. An apparatus according to claim 51, further comprising:
a first mechanical system for moving the first prism, the first mechanical system having an active configuration for recording holograms and a non-active configuration for moving the holographic medium.

55. An apparatus according to claim 54, further comprising: an auxiliary mechanical system for moving the holographic medium when the first mechanical system is in the non-active configuration.

56. An apparatus according to claim 55, wherein
the first mechanical system has a first end connected to the first prism and a second end connected to a first support position, and
the auxiliary mechanical system has a first end connected to the holographic medium and a second end connected to an auxiliary support position.

57. An apparatus according to claim 56, wherein the first mechanical system includes a first mechanical arm having a pinned connection with the first prism.

58. An apparatus according to claim 51 further comprising:
an index-matching fluid applied to at least one of the contact surface of the first prism and the first surface of the holographic medium.

59. An apparatus according to claim 51, further comprising:
a soft index-matched material applied to at least one of the contact surface of the first prism and the first surface of the holographic medium.

60. An apparatus according to claim 51, further comprising:
an ionizing static reduction system for reducing contamination of the first prism and the holographic medium.

61. An apparatus according to claim 51, wherein a central ray of the object beam is normal to the object surface of the first prism.

62. An apparatus according to claim 51, wherein a central ray of the reference beam is normal to the reference surface of the first prism.

63. An apparatus according to claim 51, wherein the holographic medium is a planar medium.

64. An apparatus according to claim 51, further comprising:
a second prism, the second prism having a contact surface for contact with a second surface of the holographic medium, and an object surface for exit of the object beam from the second prism, wherein
the second prism is disposed so that the object beam exits the holographic medium at its second surface, enters the second prism at its contact surface, and exits the second prism at its object surface.

65. An apparatus according to claim 64, further comprising:
a reference beam source for generating the reference beam; and
an object beam source for generating the object beam.

66. An apparatus according to claim 64, wherein the first prism and the second prism each have an index of refraction that is approximately equal to an index of refraction of the holographic medium.

67. An apparatus according to claim 64, further comprising:
a first mechanical system for moving the first prism, the first mechanical system having an active configuration for recording holograms and a non-active configuration for moving the holographic medium; and
a second mechanical system for moving the second prism, the second mechanical system having an active configuration for recording holograms and a non-active configuration for moving the holographic medium

68. An apparatus according to claim 67, further comprising: a third mechanical system for moving the holographic medium when the first mechanical system and the second mechanical system are each in non-active configurations.

69. An apparatus according to claim 68, wherein
the first mechanical system has a first end connected to the first prism and a second end connected to a first support position,
the second mechanical system has a first end connected to the second prism and a second end connected to a second support position, and
the third mechanical system has a first end connected to the holographic medium and a second end connected to a third support position.

70. An apparatus according to claim 69, wherein
the first mechanical system includes a first mechanical arm having a pinned connection with the first prism; and
the second mechanical system includes a second mechanical arm having a pinned connection with the second prism.

71. An apparatus according to claim 64, further comprising:
an index-matching fluid applied to at least one of the contact surface of the first prism and the first surface of the holographic medium and applied to at least one of the contact surface of the second prism and the second surface of the holographic medium.

72. An apparatus according to claim 64, further comprising:
a soft index-matched material applied to at least one of the contact surface of the first prism and the first surface of the holographic medium and applied to at least one of the contact surface of the second prism and the second surface of the holographic medium.

73. An apparatus according to claim 64, further comprising:
an ionizing static reduction system for reducing contamination of the first prism, the second prism, and the holographic medium.

74. An apparatus according to claim 64, wherein a central ray of the object beam is normal to the object surface of the first prism and the object surface of the second prism.

75. An apparatus according to claim 64, wherein a central ray of the reference beam is normal to the reference surface of the first prism.

76. An apparatus according to claim 64, wherein the object beam has an even symmetry with respect to a plane halfway between the object surface of the first prism and the object surface of the second prism.

77. An apparatus according to claim 64, wherein the holographic medium is a planar medium.

78. An apparatus for recording holograms, comprising:
a reference beam source for generating a reference beam;
an object beam source for generating an object beam.
a holographic medium;
a first prism, the first prism having a contact surface for contact with a first surface of the holographic medium, an object surface for entry of the object beam into the first prism, and a reference surface for entry of the reference beam into the first prism;
a first mechanical system for moving the first prism, the first mechanical system having an active configuration for recording holograms and a non-active configuration for moving the holographic medium;
an auxiliary mechanical system for moving the holographic medium when the first mechanical system is in the non-active configuration, wherein
the first prism is disposed so that the object beam enters the first prism at its object surface, exits the first prism at its contact surface, and enters the holographic medium at its first surface, and the reference beam enters the first prism at its reference surface, exits the first prism at its contact surface, and enters the holographic medium at its first surface, and
an interference between the object beam and the reference beam records a hologram in the holographic medium.

79. An apparatus for reading holograms, comprising:
a holographic medium; and
a first prism, the first prism having a contact surface for contact with a first surface of the holographic medium, and a reference surface for entry of a reference beam into the first prism;
a second prism, the second prism having a contact surface for contact with a second surface of the holographic medium, and an object surface for exit of an object beam from the second prism, wherein
the first prism is disposed so that the reference beam enters the first prism at its reference surface, exits the first prism at its contact surface, and enters the holographic medium at its first surface,
a diffraction of the reference beam from a hologram in the holographic medium generates an object beam, and
the second prism is disposed so that the object beam exits the holographic medium at its second surface, enters the second prism at its contact surface, and exits the second prism at its object surface.

80. An apparatus according to claim 79, further comprising:
a reference beam source for generating the reference beam.

81. An apparatus according to claim 79, wherein the first prism and the second prism each have an index of refraction that is approximately equal to an index of refraction of the holographic medium.

82. An apparatus according to claim 79, further comprising:
a first mechanical system for moving the first prism, the first mechanical system having an active configuration for reading holograms and a non-active configuration for moving the holographic medium; and
a second mechanical system for moving the second prism, the second mechanical system having an active configuration for reading holograms and a non-active configuration for moving the holographic medium

83. An apparatus according to claim 82, further comprising: a third mechanical system for moving the holographic medium when the first mechanical system and the second mechanical system are each in non-active configurations.

84. An apparatus according to claim 83, wherein
the first mechanical system has a first end connected to the first prism and a second end connected to a first support position,
the second mechanical system has a first end connected to the second prism and a second end connected to a second support position, and
the third mechanical system has a first end connected to the holographic medium and a second end connected to a third support position.

85. An apparatus according to claim 84, wherein
the first mechanical system includes a first mechanical arm having a pinned connection with the first prism; and
the second mechanical system includes a second mechanical arm having a pinned connection with the second prism.

86. An apparatus according to claim 79, further comprising:
an index-matching fluid applied to at least one of the contact surface of the first prism and the first surface of the holographic medium and applied to at least one of the contact surface of the second prism and the second surface of the holographic medium.

87. An apparatus according to claim 79, further comprising:
a soft index-matched material applied to at least one of the contact surface of the first prism and the first surface of the holographic medium and applied to at least one of the contact surface of the second prism and the second surface of the holographic medium.

88. An apparatus according to claim 79, further comprising:
an ionizing static reduction system for reducing contamination of the first prism, the second prism, and the holographic medium.

89. An apparatus according to claim 79, wherein a central ray of the object beam is normal to an object surface of the first prism and the object surface of the second prism.

90. An apparatus according to claim 79, wherein a central ray of the reference beam is normal to the reference surface of the first prism.

91. An apparatus according to claim 79, wherein the object beam has an even symmetry with respect to a plane halfway between an object surface of the first prism and the object surface of the second prism.

92. An apparatus according to claim 79, wherein the holographic medium is a planar medium.

93. An apparatus for reading holograms, comprising:
a reference beam source for generating a reference beam;
a holographic medium;
a first prism, the first prism having a contact surface for contact with a first surface of the holographic medium, and a reference surface for entry of the reference beam into the first prism;
a second prism, the second prism having a contact surface for contact with a second surface of the holographic medium, and an object surface for exit of an object beam from the second prism,
a first mechanical system for moving the first prism, the first mechanical system having an active configuration for reading holograms and a non-active configuration for moving the holographic medium;
a second mechanical system for moving the second prism, the second mechanical system having an active configuration for reading holograms and a non-active configuration for moving the holographic medium; and
a third mechanical system for moving the holographic medium when the first mechanical system and the second mechanical system are each in non-active configurations, wherein
the first prism is disposed so that the reference beam enters the first prism at its reference surface, exits the first prism at its contact surface, and enters the holographic medium at its first surface,
a diffraction of the reference beam from a hologram in the holographic medium generates an object beam, and
the second prism is disposed so that the object beam exits the holographic medium at its second surface, enters the second prism at its contact surface, and exits the second prism at its object surface.
